(19) United States
(12) Patent Application Publication
(10) Pub. No.: US 2011/0289909 A1
(43) Pub. Date: Dec. 1, 2011

(54) TORQUE CONVERTER WITH ASYMMETRIC BLADE SPACING

(75) Inventor: Bhaskar MARATHE, Clinton Twp., MI (US)

(73) Assignee: SCHAEFFLER TECHNOLOGIES GMBH & CO. KG, Herzogenaurach (DE)

(21) Appl. No.: 13/149,598

(22) Filed: May 31, 2011

Related U.S. Application Data
(60) Provisional application No. 61/350,292, filed on Jun. 1, 2010.

(51) Int. Cl. F16H 41/24; F01D 5/14

(52) U.S. Cl. 60/330; 416/203

(57) ABSTRACT

A blade assembly for a torque converter including a plurality of blades installed between a shell and a core ring, where the blades are in an arrangement having asymmetrical spacing between the blades for reducing the noise generated by operation of the torque converter.

### CROSS REFERENCE TO PRIOR APPLICATIONS

This application claims the benefit under 35 U.S.C. §119(e) of U.S. Provisional Patent Application No. 61/350,292, filed on Jun. 1, 2010, which application is incorporated herein by reference.

### FIELD OF THE INVENTION

The invention broadly relates to automobile torque converters, more specifically to torque converter pumps and turbines, and even more particularly to an arrangement of the blades of a pump or turbine of a torque converter.

### BACKGROUND OF THE INVENTION

Torque converters are well known in the art. For example, FIG. 2 depicts an example of a torque converter. Torque converter 10 includes cover 11 which houses pump 12 and turbine 13. Pump 12 includes blades 14 which are secured between outer shell 15 and core ring 16, while turbine 13 includes blades 17 secured between shell 18 and core ring 19. As is known, the pump and turbine interact with each other and other components of the torque converter (e.g., the stator, clutches, damper, input and output shafts, etc.) to transfer torque through hydraulic and mechanical means.

FIG. 1 illustrates blade assembly 1. Blade assembly 1 could be, for example, either for a pump or for a turbine. Assembly 1 includes blades 2, with each blade spaced angle α from each adjacent blade. That is, the blades are all equally spaced by angle α, which angle is determined by dividing 360° by the number of blades. In the shown embodiment, twelve blades 2 are shown, so angle α between each set of adjacent blades is equal to approximately 30°. It should of course be appreciated that any other number of blades may be included.

Blades 2 are secured between shell 3 and ring 5. That is, in various embodiments shell 3 could be a pump or turbine shell, such as shells 15 or 18, and ring 5 could be for a pump or turbine, such as rings 16 or 19. Blades 2 are secured to shell 3 and ring 5 by any suitable means known in the art. For example, in the shown embodiment, blades 2 are affixed to shell 3 by tabs 7 (the tabs mostly hidden behind the shell for securing the blade to the shell), while the blades are secured to ring 5 by tabs 9. Tabs 7 and 9 could be replaced by or supplemented with brazing, welds, pins, bolts, or any other suitable securing means known in the art.

Due to the standard or uniform spacing of angle α between the blades, assembly 1 may tend to vibrate or create noise at certain frequencies, dependent at least partially on the spacing between the blades. That is, since the angle is uniform, the blades of the assembly will tend to vibrate or create more noise at certain frequencies which correspond to this spacing. Specifically, the blades of the torque converter operate at a certain uniform time interval with the other components of the torque converter due to the uniform spacing of the blades, which creates a higher magnitude of noise at the frequency associated with that time interval. Noise becomes an even greater problem as smaller converters are utilized for more demanding applications.

Attempts have been made in the art to achieve quieter operation of torque converters. However, these attempts have been in the form of relatively costly and complicated assembly processes to add notches, slots, bumps, etc., to the leading and trailing edges of the blades. Thus, what is needed is an alternate means by which quieter operation of a torque converter can be achieved without the need to change the manufacturing process of the blades.

### BRIEF SUMMARY OF THE INVENTION

The present invention broadly comprises a blade assembly for a torque converter including a plurality of blades installed between a shell and a core ring, where the blades are in an arrangement having asymmetrical spacing between the blades. In one embodiment, the arrangement comprises a staggered, randomized, or inconsistent angular spacing between each pair of adjacent blades. In one embodiment, the arrangement comprises an increasing angular spacing pattern between each successive pair of adjacent blades. In one embodiment, the increasing angular spacing is arranged in a counter-clockwise direction. In one embodiment, the increasing angular spacing is arranged in a clockwise direction. In one embodiment, no angular space between two adjacent blades is equal in size to any other of angular space between any other two adjacent blades. In one embodiment, a torque converter includes the blade assembly. In another embodiment, a turbine comprises the blade assembly. In one embodiment, a pump comprises the blade assembly.

The present invention also broadly comprises a blade assembly for a torque converter including a plurality of blades, where a plurality of angular spaces are defined by the blades, where one space is formed between each pair of adjacent blades, and where not all of the spaces are equal in size. In one embodiment, no two spaces are equal in size. In one embodiment, the plurality of spaces includes a first space and a last space, where starting from the first space, which first space is smaller than every other space in the plurality, the spaces are arranged in a pattern where each successive space in the plurality is larger than each previous space in the plurality, the pattern terminating in the final space, where the final space is larger than every other space in the plurality and borders the first space on one side. In one embodiment, where the plurality of spaces comprises a plurality of differently sized spaces and where the spaces are arranged in a staggered, randomized or non-uniform manner.

It is a general object of the present invention to provide a torque converter blade assembly that includes a variety of differently sized angular spaces between blades of the assembly so that the different blade spaces correspond to multiple frequencies, unlike traditional assemblies having a uniform blade spacing.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a front view of a torque converter blade assembly;

FIG. 2 is a cross-sectional view of a torque converter;

FIG. 3 is a front view of a blade assembly having an increasing angular blade spacing; and,

FIG. 4 is a front view of a blade assembly having a staggered or randomized angular blade spacing.

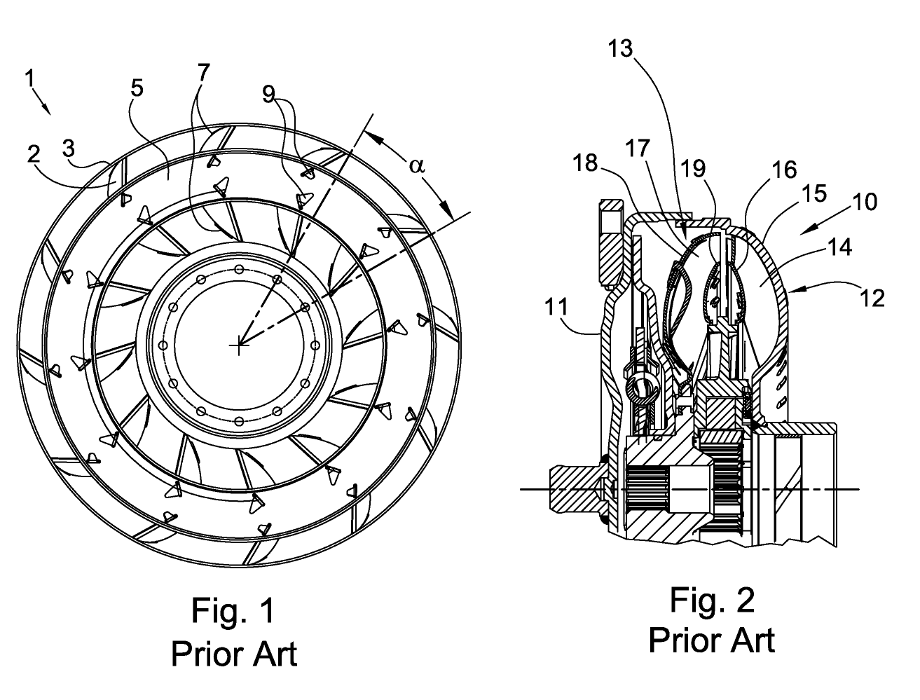

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

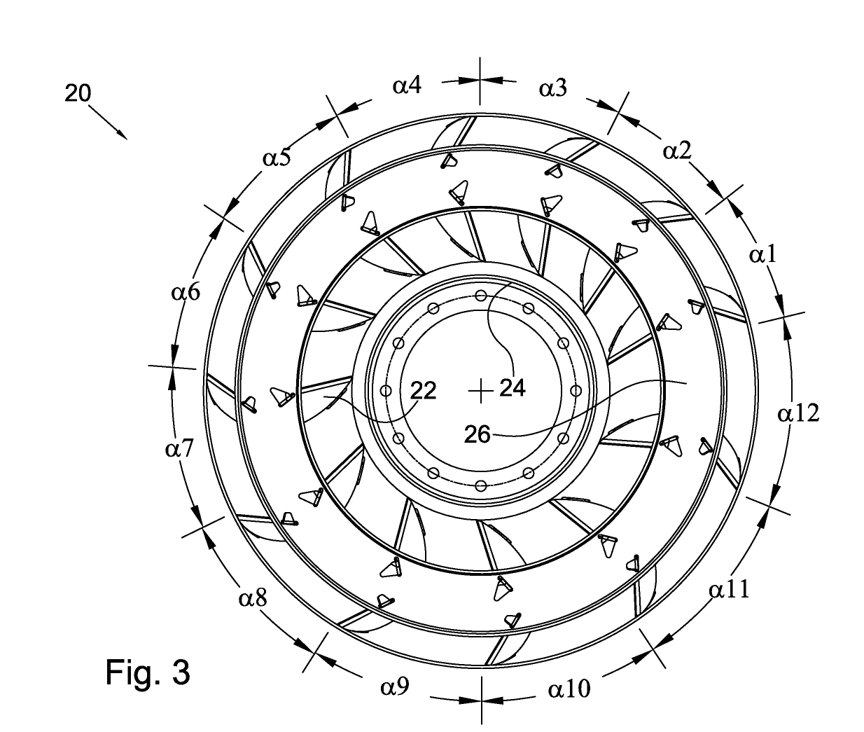

Referring now to the figures, FIG. 3 shows blade assembly 20 according to one embodiment of the current invention, the assembly having blades 22 which are arranged to have a systematic increasing angular blade spacing. Assembly 20 includes blades 22 which are secured between shell 24 and core ring 26. In the shown embodiment of FIG. 3, assembly 20 includes blades which are positioned so that the angle between each successive pair of blades is greater than the previous spacing. For example, the embodiment of FIG. 3 includes a first pair of blades spaced apart by angle α1, which angle is smaller than the angle between any other pair of blades. Going in a counter-clockwise direction, it can be seen that the next angular spacing, angle α2, is greater than the spacing of angle α1. Continuing around the assembly in the counter-clockwise direction, it can be seen that: angle α1<α2<α3<α4<α5<α6<α7<α8<α9<α10<α11<α12. In this specific embodiment, angles αα-α12 are equal to 24.5°, 25.5°, 26.5°, 27.5°, 28.5°, 29.5°, 30.5°, 31.5°, 32.5°, 33.5°, 34.5°, and 35.5°, respectively. It can be seen that each successive blade spacing is larger than the last. This is what is meant by assembly 20 having blades 22 arranged with a systematic increasing angular spacing. It should of course be understood that the blades could be spaced any other amount, and that the angles may also vary depending on the number of blades included in the assembly. In the example shown, each successive blade spacing increases by 1° from the previous spacing. In other embodiments, the blade spacing may be greater or less than 1° or may vary so that it is not consistent from spacing to spacing (e.g., angle α1 could be 1° less than angle α2, which is in turn 1.5° less than angle α3).

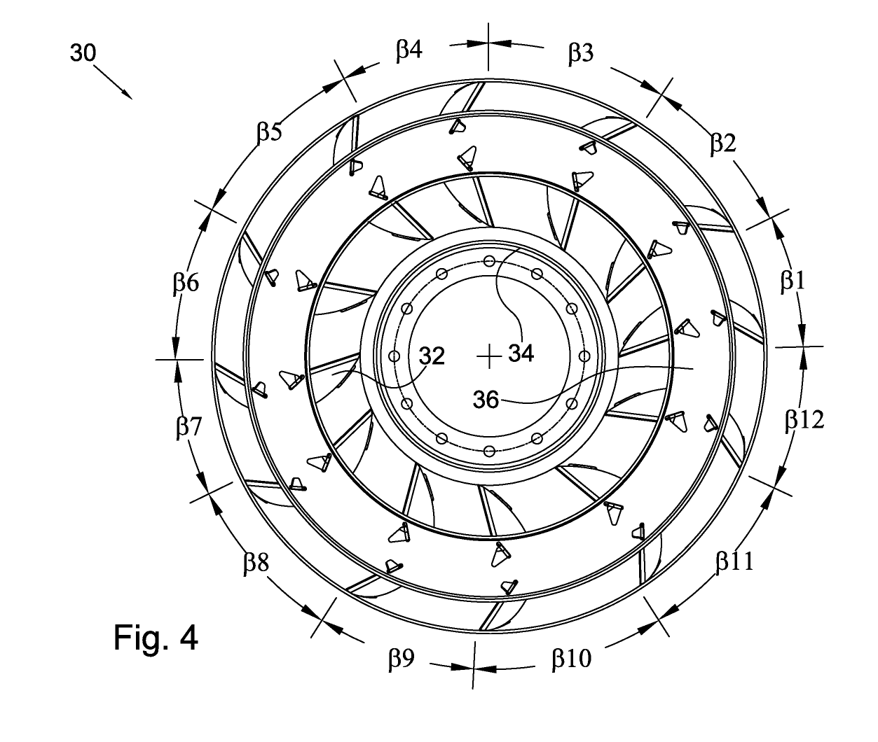

FIG. 4 shows a blade assembly 30 according to the current invention, the assembly having blades 32 which are arranged to have a staggered angular blade spacing. Assembly 30 includes blades 32 which are secured between shell 34 and core ring 36. In the shown embodiment of FIG. 4, assembly 30 includes blades which are positioned so that the angle between each successive pair of blades is not consistently greater or less than the previous spacing. Instead, assembly 30 presents a randomized or staggered arrangement. For example, the embodiment of FIG. 4 includes a first pair of blades spaced apart by angle β1, which angle is smaller than the angle between any other pair of blades. Going in a counter-clockwise direction, it can be seen that the next angular spacing, angle β2, is greater than the spacing of angle β1, and that angle β3 is also greater than angle β2, but that angle β4 is less than angles β2 and β3. Continuing around the assembly in a counter-clockwise direction, it can be seen that: angle β1<β7<β12<β4<β6<β9<β2<β8<β11<β3<β5<β10. In this specific embodiment, angles β1-β12 are equal to 24.5°, 30.5°, 33.5°, 27.5°, 34.5°, 28.5°, 25.5°, 31.5°, 29.5°, 35.5°, 32.5°, and 26.5°, respectively. It can be seen that there is no apparent pattern to the spacing between each successive pair of blades. This is what is meant by assembly 20 having blades 22 arranged with a staggered or random angular spacing. The angles may be determined by any randomizing means known in the art, or may be pre-determined and selectively assigned to positions. The staggered or randomized arrangement may be preferred because it intermingles large, small, and medium sized spaces together in no particular order so that not all of the smallest or largest spaces are grouped together as in assembly 20, which for example, could result in an uneven stress distribution that might cause distortion of the assembly. By randomizing, any such possible distortion effects should be mitigated.

It should be appreciated, that in some embodiments, angles may be repeated (i.e., two or more angles may be equal in size). It should of course be understood that the blades could be spaced any other amount, and that the angles may also vary depending on the number of blades included in the assembly. For example, if more blades were included, then the angular spacing may be reduced to 5° or less, while if fewer blades were used, the spacing may be increased to 60° or more. Furthermore, the blades may be arranged in some other pattern. By asymmetrical it is generally meant non-uniform, although some patterns which are technically symmetric may fall within the scope of the current invention. As an example of a symmetric pattern which falls within the scope of the current invention, the spaces could be arranged in a repeated or alternating large-small arrangement (i.e., first space is smaller than second space, second space is larger than third space, third space is smaller than fourth space, etc.), with all of the “large” spaces equal in size and all of the “small” spaces also equal in size. However, due to the symmetry of such an arrangement, it may be found that the noise is split into only two main frequencies (one frequency for each spacing size), and therefore this arrangement may not operate as quietly as the others presented herein. As an alternative to this arrangement, all of the “small” or “large” spaces could be a different size. Thus, it should be appreciated that any other pattern or arrangement could be used, and the number of blades, size of the spaces, or variation in size between the spaces can be altered as desired as long as at least one of the spaces is not equal in size to at least one other space.

By varying the spacing of the blades, the wake frequency of passing blades is split between several frequencies. That is, typically the torque converter fluid noise and fluid pressure induced mechanical noise and vibrations correspond to one specific frequency due to the wake of blades from one component (e.g., the turbine, pump, or stator) interacting with the blades from the next component (e.g., the, pump, stator, or turbine) at regular uniform intervals. The asymmetric arrangement of the blades taught by the current invention results in irregular blade interaction between the components of the torque converter, which spreads the otherwise large noise magnitude out over a multitude of smaller noise magnitudes at different frequencies. That is, the noise created by the blades is spread over a band of frequencies, at each of which frequencies the noise has a smaller magnitude, instead of a single frequency which results in a high level of noise. This results in an overall quieter operation of a torque converter.

It should be understood that blades 22 and 32, shells 24 and 34, and rings 26 and 36 generally resemble blades 2, 14, or 17, shell 3, 15, or 18, and ring 5, 16, or 19, respectively, except that the blades for assemblies 20 and 30 are not uniformly spaced, as described above. Furthermore, it should be recognized that assemblies 20 and 30 could be utilized by a pump or turbine of a torque converter, such as pump 12 and turbine 13 of torque converter 10. Also, the means in the shell and/or core ring for receiving the tabs for holding the blades to the shell and/or ring must be spaced to correspond to the arrangement of the blades. Therefore, the core ring and/or shell preferably include a marking, indicia, indication, feature, etc., to help align the core ring with the blades and the shell after the blades have been installed in the shell. For example, features, such as an arrow, line, circle, etc., could be embossed into the shell and ring to enable them to be easily rotationally aligned for proper assembly. It should also be clear that any securing means known in the art could be included to secure blades 22 between shell 24 and ring 26 or blades 32 between shell 34 and ring 36, such as tabs similar to tabs 7 and/or 9.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A blade assembly for a torque converter comprising:
a plurality of blades installed between a shell and a core ring, wherein said blades are in an arrangement having asymmetrical spacing between said blades for reducing noise generated by operation of said torque converter.

2. The assembly recited in claim 1, wherein said arrangement comprises a staggered, randomized, or inconsistent angular spacing between each pair of adjacent blades.

3. The assembly recited in claim 1, wherein said arrangement comprises an increasing angular spacing pattern between each successive pair of adjacent blades.

4. The assembly recited in claim 3, wherein said increasing angular spacing pattern is arranged in a counter-clockwise direction.

5. The assembly recited in claim 3, wherein said increasing angular spacing pattern is arranged in a clockwise direction.

6. The assembly recited in claim 1, wherein no angular space between two adjacent blades is equal in size to any other of angular space between any other two adjacent blades.

7. A torque converter comprising the blade assembly of claim 1.

8. A turbine comprising the blade assembly of claim 1.

9. A pump comprising the blade assembly of claim 1.

10. A blade assembly for a torque converter comprising:
a plurality of blades, wherein a plurality of angular spaces are defined by said blades, wherein one space is formed between each pair of adjacent blades, and wherein not all of said spaces are equal in size.

11. The blade assembly recited in claim 10, wherein no two of said spaces are equal in size.

12. The blade assembly recited in claim 11, wherein said plurality of spaces includes a first space and a last space, wherein starting from said first space, which first space is smaller than every other space in said plurality, said spaces are arranged in a pattern where each successive space in said plurality is larger than each previous space in said plurality, said pattern terminating in said final space, wherein said final space is larger than every other space in said plurality and borders said first space on one side.

13. The blade assembly recited in claim 12, wherein said plurality of spaces comprises a plurality of differently sized spaces and wherein said spaces are arranged in a staggered, randomized or non-uniform manner.
